(19) United States
(12) Patent Application Publication
(10) Pub. No.: US 2024/0414280 A1
(43) Pub. Date: Dec. 12, 2024

(54) VIDEO SUPPORT IN A MULTI-APERTURE MOBILE CAMERA WITH A SCANNING ZOOM CAMERA

(71) Applicant: Corephotonics Ltd., Tel-Aviv (IL)

(72) Inventors: Nitzan Horovitz, Tel Aviv (IL); Yoav Kurtz, Tel Aviv (IL); Adi Falik, Tel Aviv (IL); Omri Levi, Tel Aviv (IL); Ruthy Katz, Tel Aviv (IL); Michael Scherer, Tel Aviv (IL); Noy Cohen, Tel Aviv (IL); Oren Zohar, Tel Aviv (IL)

(21) Appl. No.: 18/808,006

(22) Filed: Aug. 18, 2024

Related U.S. Application Data
(63) Continuation of application No. 17/829,628, filed on Jun. 1, 2022, now Pat. No. 12,101,575.
(60) Provisional application No. 63/130,655, filed on Dec. 26, 2020.

(51) Int. Cl. H04N 5/268; H04N 5/262; H04N 23/45; H04N 23/63; H04N 23/667; H04N 23/68; H04N 23/69; H04N 23/80

(52) U.S. Cl. CPC H04N 5/268; H04N 5/2628; H04N 23/45; H04N 23/635; H04N 23/667; H04N 23/683; H04N 23/69; H04N 23/80

(57) ABSTRACT

Systems and methods for obtaining a seamless, smooth transition between a Wide field of view (FOV) camera and a scanning Tele camera by correcting prism aberrations, matching Tele and Wide FOVs, localizing the associated Tele FOV. and zooming a Wide frame towards the localized Tele FOV.

### CROSS REFERENCE TO RELATED APPLICATIONS

This is a continuation application of U.S. patent application Ser. No. 17/829,628 filed Jun. 1, 2022 (now allowed), which was a 371 application from international patent application No. PCT/IB2021/062305 filed Dec. 24, 2021, and claims the benefit of priority from U.S. Provisional patent application No. 63/130,655 filed Dec. 26, 2020, which is incorporated herein by reference in its entirety.

### FIELD

Embodiments disclosed herein relate in general to mobile cameras and in particular to video support in multi-aperture cameras in the presence of a scanning camera

### BACKGROUND

Multi-cameras, of which dual-cameras are a sub-category, are standard in modern mobile electronic handheld devices (“mobile devices”, e.g. smartphone, tablet, etc.). A multi-camera usually comprises a Wide angle or field of view (FOV_{w}) camera (“Wide camera” or “WC”), and one or more additional cameras, either with a narrower FOV (Telephoto or “Tele” camera having a “native FOV_{T}” or “n-FOV_{T}”) or with an Ultra-Wide FOV (FOV_{UW}).

“Scanning Tele cameras” (“STCs”) cover or “scan” a segment of a scene that is larger than the n-FOV_{T}. This segment is referred to as “scanning Tele FOV” or “s-FOV_{T}”. The FOV scanning may be performed by rotating one or more optical path folding elements (“OPFEs”). A STC is described for example in co-owned U.S. Pat. No. 10,578,948.

For dual-cameras including a WC and a Tele camera, while a user zooms in or out in a video operation mode (image stream), either a Wide or a Tele image is displayed to the user. When switching the “active” camera, i.e. switching the camera from which the output image is displayed (from Tele to Wide or vice versa), the user will see a “jump”, or discontinuity in the video. This jump is amongst others caused by the different points of view (POVs) of the two or more cameras. A POV of a camera is defined as a unity vector and it is fully described by a point of origin and a direction. The point of origin is the center of the aperture of the respective camera. The POV's direction is given by the linear connection between the point of origin and the center of a particular FOV of the respective camera. In known dual-cameras included in mobile devices, the points of origin of the two cameras differ slightly by e.g. 5-25 mm.

A “smooth transition” (ST) in the displayed video is a software feature that minimizes the jump when switching between image streams of different cameras (having different POVs). In current multi-cameras, a center of FOV_{T} is substantially identical with a center of FOV_{W} (i.e. the center of FOV_{T} and the center of FOV_{W} are substantially identical). With respect to a mobile device such as a smartphone that includes the multi-camera, both the Wide camera's POV and the Tele camera's POV are substantially parallel to a normal on the smartphone's rear surface. However, for a STC, n-FOV_{T} and POV are not fixed, but they scan within s-FOV_{T}. Therefore, in general a center of n-FOV_{T} and a center of FOV_{W} are not identical and, when included in a smartphone, the STC's POV is not parallel to a normal on the smartphone's rear surface.

There is need and it would be beneficial to have a smooth transition feature for smooth switching between Wide images (“WIs) and scanning Tele images (“ STIs ”) within a video image stream.

### SUMMARY

Disclosed herein are systems and methods for obtaining a smooth (i.e. seamless) transition between cameras or POVs that minimizes the jump effect occuring in a video operation mode when switching from displaying Wide image data to scanning Tele image data during zooming-in (“ zoom-in ”) or when switching from displaying scanning Tele image data to Wide image data during zooming-out (“ zoom-out ”). Hereinafter and for simplicity, “Wide image data” may be replaced by just “Wide image” or “WI”, and “scanning Tele image data” may be replaced by just “STC data”, “scanning Tele image”, or “STI”.

In various examples, there are provided zoom cameras comprising: a Wide camera with a FOV_{W} and operative to output Wide images (WIs); a STC with a Tele FOV (n-FOV_{T}) narrower than FOV_{W} and operative to output STIs; and a camera controller operatively coupled to the Wide camera and to the STC and configured to stream a video image stream that displays a continuous zoom-in action into, or a continuous zoom-out action out off a non-center area within FOV_{W}, wherein the video images are provided with a smooth transition when switching from displaying WIs to displaying scanning STIs or vice versa.

In some examples, the smooth transition may be achieved by one or more of the following: performing a rotation correction of the STIs, executing registration between the WIs and the STIs, or executing a localization between the WIs and the STIs for performing position matching. The localization between the WIs and the STIs may improve the accuracy of the position matching with respect to the position matching before the localization by more than 2.5 times or even by more than 10 times.

In some examples, the smooth transition may be achieved by one of the following: shifting STIs relative to WIs according to a distance of an object in a scanning Tele image region of interest (ROI) when switching from displaying the WIs to displaying the STIs, and/or by shifting the WIs relative to the STIs according to a distance of an object in a Wide image ROI when switching from displaying the STIs to displaying the WIs; applying blurring on the WIs and/or the STIs; blending WIs and STIs; matching scale and/or brightness and/or color between WIs and STIs; or cropping WIs such that respective crop offsets of sequentially displayed WIs lie on a line. The cropping of the WIs may include cropping such that a distance between the respective crop offsets of sequentially displayed WIs changes linearly with a zoom factor, or cropping such that a distance between the respective crop offsets of sequentially displayed WIs changes according to a square of a zoom factor. A crop offset and/or a crop center and/or a crop factor may be selected such that a selected object is included in a cropped scanning Tele image displayed to a user. The selected object may be located at a particular position within the cropped scanning Tele image.

In some examples, the smooth transition may be achieved by cropping WIs such that respective coordinates of a FOV_{W} center of sequentially displayed WIs lie on a line. The cropping of the WIs may include cropping such that a distance between the respective coordinates of the FOV_{W} center of sequentially displayed WIs changes linearly with a zoom factor, or cropping such that a distance between the respective coordinates of the FOV_{W} center of sequentially displayed WIs changes according to a square of the zoom factor.

In some examples, the smooth transition may be achieved by cropping of the WIs such that a particular target area is always displayed in the video image stream, or cropping WIs such that the respective coordinates of a particular target area in sequentially displayed WIs lie on a line. The cropping may be such that a distance between the respective coordinates of the particular target area in sequentially displayed WIs changes linearly, or according to a square law.

In some examples, the switching from displaying WIs to displaying STIs may be performed at an up-transfer ZF value (ZF_{UP}), wherein the switching from displaying STIs to displaying WIs is performed at a down-transfer ZF value (ZF_{DOWN}), and wherein ZF_{UP}≥ZF_{DOWN}.

In some examples, the switching from displaying STIs to displaying WIs may be performed at a down-transfer ZF value (ZF_{DOWN}) that depends on a point-of-view (POV) of a native-FOV_{T} (n-FOV_{T}) within the FOV_{W}, i.e. ZF_{DOWN}=ZF_{DOWN} (x,y), wherein ZF_{DOWN}(center POV) is a down-transfer ZF value of a center POV within FOV_{W}, wherein ZF_{DOWN} (margin POV) is a down-transfer ZF value of a margin POV within FOV_{W}, and wherein ZF_{DOWN} (center POV)<ZF_{DOWN} (margin POV).

In some examples, the switching from displaying WIs to displaying STIs may be performed at an up-transfer ZF value (ZF_{UP}), wherein ZF_{UP} does not depend on the POV of a native FOV_{T} (n-FOV_{T}) within FOV_{W}, wherein [ZF_{DOWN}(x,y)]_{MAX} is a maximal value of ZF_{DOWN}(x,y) for all possible POVs within a scanning FOV (s-FOV_{T}) of the STC, wherein ZF_{UP}≥[ZF_{DOWN}(x, y)]_{MAX}.

In some examples, the switching from displaying WIs to displaying STIs may be performed at a ZF_{UP} that depends on a POV of a n-FOV_{T} within the FOV_{W}, wherein ZF_{UP}=ZF_{UP}(x,y).

In some examples, the switching from displaying WIs to displaying STIs may be performed at a ZF_{UP} and the switching from displaying STIs to displaying WIs may be performed at ZF_{DOWN}, wherein the values of ZF_{UP} and/or ZF_{DOWN} in a video photography mode are 5%-30% larger than the values of ZF_{UP} and/or ZF_{DOWN} in a stills photography mode. The values of ZF_{UP} and/or ZF_{DOWN} may depend on aspect ratios of, respectively, the Wide and STIs displayed to a user. The values of ZF_{UP} and/or ZF_{DOWN} in a digital image-stabilized video mode may be 5%-30% larger than the values of ZF_{UP} and/or ZF_{DOWN} in a non-image-stabilized video mode.

In some examples, in a digital image-stabilized video mode, an image stabilization capability at a center POV may be 5%-30% larger than an image stabilization capability at a margin POV.

In some examples, the smooth transition may be achieved by cropping the STIs such that a particular position of a selected object in the cropped STI displayed to the user in two consecutive images of the video image stream does not vary by >10 pixels. In some examples, the particular position of the selected object may not vary by >5 pixels. In some examples, the particular position of the selected object in the cropped scanning Tele image displayed to the user may be selected according to aesthetic criteria.

In some examples, the camera controller may additionally configured to evaluate a non-switching criterion before the switching from displaying WIs to displaying STIs, and, if the non-switching criterion is met, not to switch from displaying WIs to displaying STIs. The non-switching criterion may be selected from a group consisting of a motion blur, electronic noise, a rolling shutter, a defocus blur and an incorrect image alignment or obstruction. The non-switching criterion may include a significant mis-location of a ROI in the STI with respect to its position in a WI or absence of the ROI in the STI; an imperfect roll correction of the STI; a check to determine if target coordinates are included in a scanning FOV of the STC (s-FOV_{T}); a check to determine if target coordinates are close to margins of the s-FOV_{T} to prevent jumping back and forth between the WI and the STI; or a check to determine if target coordinates move faster than an expected maximum prism scanning velocity.

A zoom camera as above or below may be included in a smartphone.

In some examples, there is provided a method, comprising: using a Wide camera with a FOV_{W} to output WIs; using a STC with a n-FOV_{T} narrower than FOV_{W} to output STIs; and configuring a camera controller operatively coupled to the Wide camera and to the STC to stream a video image stream that displays a continuous zoom-in action into, or a continuous zoom-out action out off a non-center area within FOV_{W}, and to provide the video images with a smooth transition when switching from displaying the WIs to displaying the STIs or vice versa.

### BRIEF DESCRIPTION OF THE DRAWINGS

Non-limiting examples of the presently disclosed subject matter are described below with reference to figures attached hereto that are listed following this paragraph. Identical structures, elements or parts that appear in more than one figure may be labeled with the same numeral in the figures in which they appear. The drawings and descriptions are meant to illuminate and clarify embodiments disclosed herein, and should not be considered limiting in any way.

FIG. 1 shows schematically an embodiment of a mobile device that includes multi-cameras as disclosed herein;

FIG. 2 shows different OPFE positions and their respective FOVs in an object domain;

FIG. 3 shows in a flow chart main steps of a method for locating a STC image within a Wide image as disclosed herein;

FIG. 4A shows the localization of the T image within the W image in one view;

FIG. 4B shows the localization of the T image within the W image in another view;

FIG. 5A shows a zoom-in scenario displayed in a smooth transition video sequence created by a first method embodiment;

FIG. 5B shows images in the zoom-in scenario of FIG. 5A, zoomed digitally such that they have the same width/height ratio;

FIG. 5C shows some of the images in FIG. 5B and a target position;

FIG. 6 shows in flow chart with main steps of a crop method;

FIG. 7 shows another embodiment of a method disclosed herein for achieving a smooth-transition experience in multi-cameras comprising at least one camera with a scanning capability.

### DETAILED DESCRIPTION

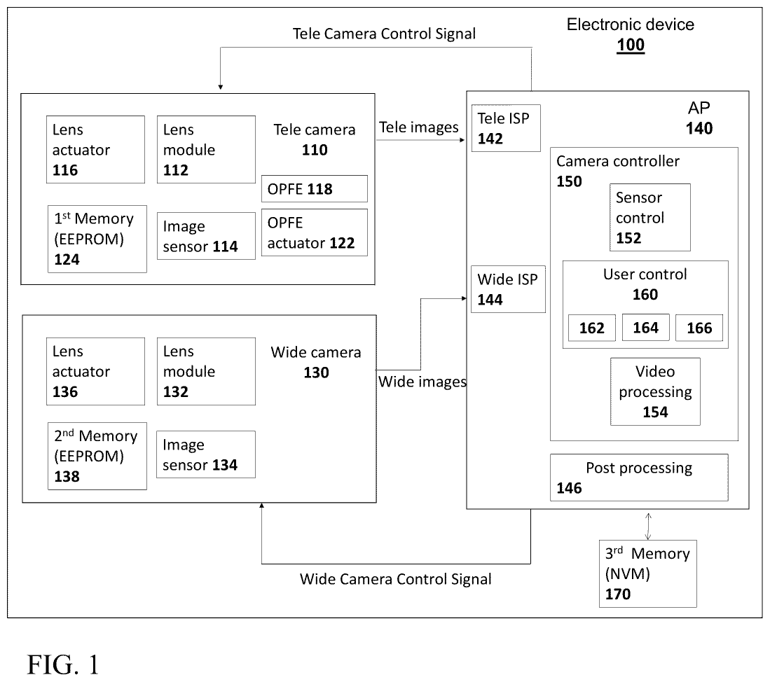

FIG. 1 shows schematically an embodiment of mobile device numbered 100 (e.g. a smartphone) that includes a dual-camera. The dual-camera comprises a scanning Tele camera (“STC”) 110 with a given native FOV_{T} (“n-FOV_{T}”) and an effective or scanning FOV_{T} (“s-FOV_{T}”). STC 110 may be a folded camera that includes an OPFE 118, a Tele lens module 112 with a Tele lens, and a Tele image sensor 114. The Tele lens may have a fixed effective focal length (EFL) providing a fixed zoom factor (ZF), or an adaptable (variable) EFL providing an adaptable ZF. The adaption of the EFL may be discrete or continuous. STC 110 further comprises a lens actuator 116 for moving lens module 112 for focusing and/or optical image stabilization (OIS), an OPFE actuator 122 for actuating OPFE 118 for OIS and/or for scanning n-FOV_{T} to a particular point-of-view (POV) within s-FOV_{T}, and a first memory 124. Memory 124 may be an EEPROM (electrically erasable programmable read only memory). In some embodiments, first memory 124 may store first calibration data. STC 110 may have an EFL of e.g. 8 mm-50 mm or more, a diagonal n-FOV_{T} of 10-40 deg, and a f number of about f/#=1.5-6.

The n-FOV_{T} scanning occurs with a finite maximum velocity, i.e. it requires some settling time. N-FOV_{T} scanning may performed on a time scale of about 1-30 ms for scanning 2°-5° and about 10-80 ms for scanning 10-25°. In some embodiments, s-FOV may cover about 50% of the area of FOV_{W}. In some embodiments, the s-FOV_{T} may cover about 100% or even more of the area of FOV_{W}.

In some embodiments, the n-FOV_{T} scanning may be performed by actuating two or more OPFEs instead of a single OPFE, as described for example in the co-owned international patent application No. PCT/IB2021/059843.

The dual-camera further comprises a Wide camera (“WC”) 130 with a FOV_{W} larger than the n-FOV_{T} of STC 110. WC 130 includes a Wide lens module 132 with a Wide lens and a Wide image sensor 134. A second lens actuator 136 may move lens module 132 for focusing and/or OIS. In some embodiments, second calibration data may be stored in a second memory 138. In other embodiments, the first calibration data and the second calibration data may be stored in a third memory 170. The first and second calibration data may comprise calibration data between WC 130 and STC 110. The WC may have an EFL of e.g. 2.5-20 mm, a diagonal FOV of 50-130 deg and a f/#of about 1.0-2.5.

Mobile device 100 may further comprise an application processor (AP) 140. AP 140 may comprise a Wide image signal processor (ISP) 144 and a Tele image ISP 142. AP 140 may further comprise a camera controller 150 having a sensor control unit 152, a user control unit 160, a video processing unit 154 and a post-processing unit 146, all operationally coupled to image sensors 114 and 134. User control unit 160 may comprise an operational mode choice function 162 used to select whether to capture images or videos, a region of interest (ROI) function 164 used to select a ROI, a ROI's “target coordinates” or its particular POV (“particular POV” and “target coordinates” being used interchangeably in the following), and a zoom factor (ZF) module 166 used to select a ZF. The ROI may be a segment within FOV_{W} or s-FOV_{T} that is selected by a user or by an algorithm. The ROI may have a higher value to a user than other segments, e.g. because it contains particular objects or a particular composition of objects. In general, a WC is focused to one of the ROIs and a STC is steered towards and/or focused to one of the ROIs.

In use, AP 140 may receive respective Wide and STC image data from cameras 110 and 130 and supply camera control signals to cameras 110 and 130.

Sensor control unit 152 is operationally coupled to the two ISPs (142 and 144) and to the user control unit 160, and may be used to choose, according to the zoom factor, which of the image sensors is operational and to provide sensor control signals. Video processing unit 154 may be configured to evaluate no-switching criteria to make a decision regarding a video output. Specifically, upon evaluation of a no-switching criterion, if the no-switching criterion is fulfilled, module 154 may be configured to output a zoom video output image that includes only Wide image data in a zoom-in operation. Post processing module 146 may be used for image processing that may include denoising, sharpening, scaling, etc.

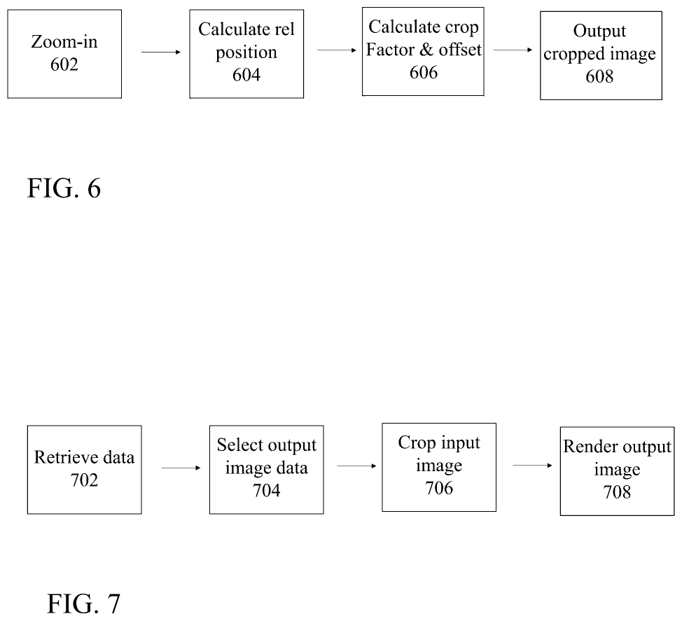

Here and in the following, and if not stated otherwise, we use the following definitions:
Input image: image as provided by a Tele ISP 142 or a Wide ISP 144.
Scanning Tele image (STI): image as provided by a Tele ISP 142.
Wide image (WI): image as provided by a Wide ISP 144.
Output image: image as displayed to a user (in general as a particular image of a video stream).
Tele output image: output image based on STI data and as provided in step 608 (FIG. 6) or step 708 (FIG. 7).
Wide output image: output image based on WI data and as provided in step 608 (FIG. 6) or step 708 (FIG. 7).
Output image data switching: in an image video stream, the action of switching from displaying to a user Tele output images or Wide output images to, respectively, displaying Wide output images or Tele output images to the user.
Hereinafter, “image data” and “image” or “images” are used interchangeably.

### Zoom-in and Zoom-out in Still Camera Mode

We define the following: TFOV =tan (camera FOV/2). “Low ZF” refers to all zoom factors that comply with ZF<TFOV_{W}/TFOV_{T}. “High ZF” refers to all ZFs that comply with ZF>TFOV_{W}/TFOV_{T}. “Transfer ZF” or “ZFT” refers to a ZF that complies with ZF =TFOV_{W}/TFOV_{T}. ZFT represents a smallest ZF that allows output image data switching. In one embodiment, zoom-in and zoom-out in still mode may be performed as follows:

Zoom-in: at low ZF up to slightly above ZFT, the output images are digitally zoomed Wide output images. At an up-transfer ZF (“ZF_{UP}”), ZF_{UP}≥ZFT, the STI is shifted and corrected as described herein to achieve smooth transition (“ST”) when output image data switching is performed, from displaying Wide output images to displaying Tele output images. For a ZF≥ZF_{UP}, the output are Tele output images that are digitally zoomed.

Zoom-out: at high ZF down to slightly above ZFT, the output images are digitally zoomed Tele output images. At a down-transfer ZF (“ZF_{DOWN}”), ZF_{DOWN}≥ZFT, the WI is shifted and corrected such as described herein to achieve ST when output image data switching is performed from displaying Tele output images to displaying Wide output images. For a ZF≤ZF_{DOWN}, the output are digitally zoomed Wide output images.

“Slightly above ZFT” may refer to a ZF that is higher by about 1%-25% than ZFT.

In some examples, a global registration algorithm may be used to achieve ST.

In some embodiments, ZF_{UP} and/or ZF_{DOWN} may be fixed ZFs, and ZF_{UP}≤ZF_{DOWN} or ZF_{UP}≥ZF_{DOWN}.

In other embodiments, ZF_{UP} and/or ZF_{DOWN} may not be fixed ZFs, but they may vary (“dynamic transfer ZF”), e.g. in dependence on a POV or target coordinates (i.e. on the position of n-FOV_{T} within s-FOV_{T}), i.e. ZF_{DOWN}=ZF_{DOWN}(x,y) and/or ZF_{DOWN}=ZF_{DOWN}(x,y), “(x,y)” representing a coordinate or POV within s-FOV_{T}.

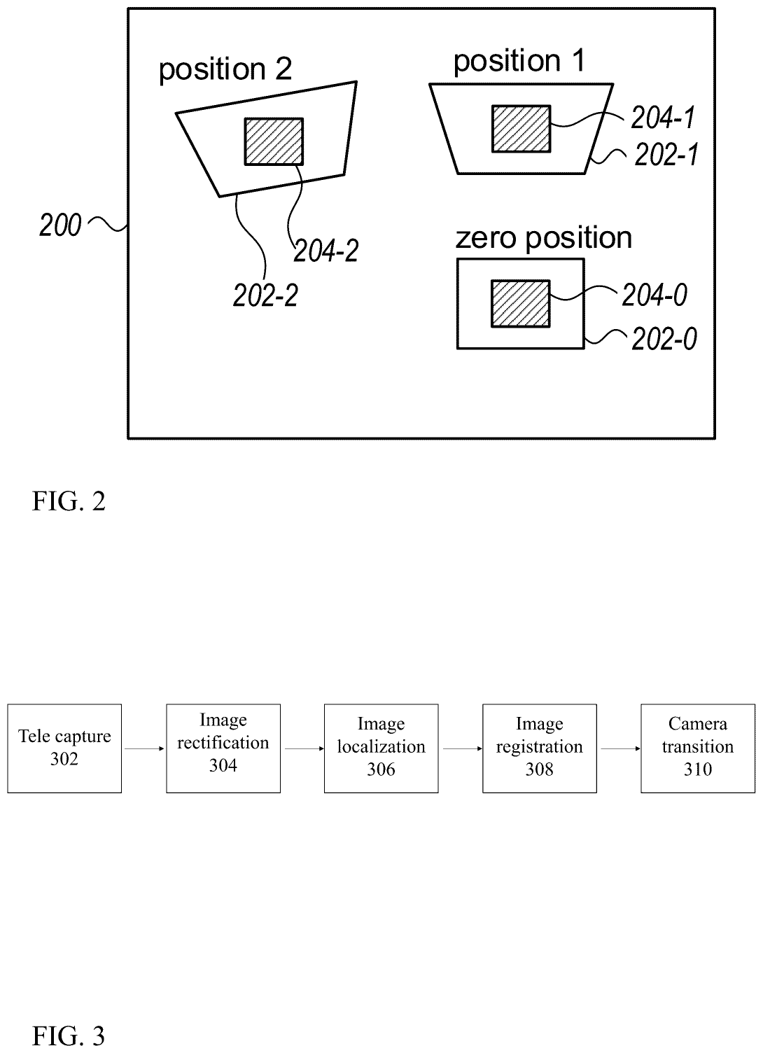

In some embodiments, ZF_{DOWN} may be smaller in a center region of s-FOV_{T} than in a margin region of s-FOV_{T}, i.e. ZF_{DOWN} (center region <ZF_{DOWN}(margin region). “Center region” and “margin region” are defined to be mutually exclusive. In an example and with reference to s-FOV_{T} 200 shown in FIG. 2, a center region may be defined by all POVs that point into a rectangular box having the same height-width ratio and the same center as s-FOV_{T} 200, but only 50% of s-FOV_{T} 200′s height and width respectively. Any POV pointing into s-FOV_{T} 200 but not pointing into the center region is included in the margin region. In other examples, the rectangular box may only have 30% of s-FOV_{T} 200's height and width respectively, or it may have as much as 80% of s-FOV_{T} 200's height and width respectively, with the definitions of center region and margin region changing accordingly. In a STC based on a single OPFE, a STI captured in a center region of s-FOV_{T} includes a larger FOV segment in an object domain than a STI captured in a margin region. This because for obtaining an e.g. rectangular rectified STI having a particular aspect ratio from a non-processed (i.e. non-corrected, uncropped etc.) STI at a center position within s-FOV_{T}, a lower amount of cropping is required (i.e. less scene information is lost) than for obtaining a rectangular rectified STI having a same particular aspect ratio from a non-processed STI at a margin position within s-FOV_{T}. The object domain is defined as the actual (or physical) scene, i.e. as the scene that is captured by an ideal camera having a sufficiently large FOV and not having any aberrations and distortions. That is, the object domain corresponds to the appearance of the scene as it may appear to a human observer. Therefore, ZF_{UP} and ZF_{DOWN} in a center region can be smaller than in a margin region.

An advantage of using dynamic transfer ZFs is that at least in a center region of s-FOV_{T}, the image quality benefits of using the STC can be enjoyed at a lower ZF. Using dynamic up-and down transfer ZFs may be especially beneficial in stills photography mode. In some embodiments with fixed or dynamic ZF_{UP} and/or ZF_{DOWN}, the values of ZF_{UP} and/or ZF_{DOWN} in a video photography mode (i.e. when a user captures a video stream) may be larger by 5%-30% than the values of ZF_{UP} and/or ZF_{DOWN} in a stills photography mode. In some embodiments, the values of ZF_{UP} and/or ZF_{DOWN} may depend on an aspect ratio of the Wide output images and/orTele output images.

In some embodiments where ZF_{UP}=ZF_{UP}(x,y), ZF_{UP}(center region)<ZF_{UP}(margin region).

In some embodiments, ZF_{UP} may be fixed and ZF_{DOWN} may be dynamic, i.e. ZF_{DOWN}=ZF_{DOWN}(x,y). A fixed ZF_{UP} may fulfill ZF_{UP}> [ZF_{DOWN} (x,y)] MAX, i.e. the fixed ZF_{UP} is defined by the maximum ZF_{DOWN} (x,y), which is the maximum ZF_{DOWN} when considering all POVs within s-FOV_{T}. This may be beneficial, as it prevents scenarios where output image data switching from STIs to WIs need to be performed even though there is no change in ZF. An example for such an undesired scenario involves tracking of a moving object with the STC after output image data switching from WIs to STIs at target coordinates at a center position (where ZF_{UP} can be smaller than in a margin region). The object (i.e. the target coordinates) may now move to a more margin position within s-FOV_{T}, where the FOV defined by the respective ZF cannot be supported with STIs anymore, because the n-FOV_{T} at this margin position is not sufficiently large. Because of the incomplete STI data, output image data switching from STIs to WIs needs to be performed, although there is no change in ZF. Using a fixed ZF_{UP} that fulfills ZF_{Up}≥[ZF_{DOWN}(x,y)]_{MAX} may be especially beneficial in a video mode.

### Smooth Transition

For achieving ST, matching the position, scale, brightness and color of output images may be performed before and/or after output image data switching. However, image position matching between entire WIs and STIs is in many cases impossible, for example because of parallax. Therefore, in a smooth transition as disclosed herein, position matching may be achieved only in the ROI region, while scale brightness and color are matched for the entire output image area. Specifically, STIs may be shifted relative to WIs according to a distance of an object in a STI ROI when switching from displaying WIs to displaying STIs, and/or by shifting WIs relative to STIs according to a distance of an object in a WI ROI when switching from displaying STIs to displaying WIs.

FIG. 2 shows different OPFE positions and their respective n-FOVTs in an object domain, as described in more detail in PCT/IB2021/056311. The object domain is differentiated from an “image domain”, which is defined as the scene captured by a camera having aberrations and distortions. In this disclosure, the image domain is defined as a scene captured by a STC such as camera 110. Box 200 represents s-FOV_{T}, i.e. a smallest rectangular FOV that includes all STC image data from all POVs that can be reached with a particular STC in the object domain. The n-FOV_{T}s for three different OPFE positions (0, 1 and 2) are represented by 202-0, 202-1 and 202-2. The n-FOV_{T} for an OPFE “zero position” 202-0 is defined as the n-FOV_{T} that produces an image of an object or scene without POV aberrations. That is, at zero position an object in the object domain is identical to the object image in the image domain (except scaling, image sensor noise etc.). In general, in the zero position the center of n-FOV_{T} and FOV_{W} overlap. As shown, the n-FOV_{T}at any other position (e.g. 202-1 and 202-2) is not a horizontal rectangle (like 202-0), but an arbitrary tetragon. The same rectangular object is represented by 204-0, 204-1 and 204-2 in, respectively, n-FOV_{T}s 202-0, 202-1 and 202-2.

FIG. 3 shows main steps of a method for locating a STI within a WI as disclosed herein. A STI is captured in step 302. Prior to the capture, n-FOV_{T} is scanned toward a particular POV. The STI is rectified in step 304, as described in international patent application PCT/IB2021/056311. By using suitable crop selection criteria, one is able to manipulate the content included in the corrected and cropped STI as well as the location of objects within the corrected and cropped STI. Crop selection criteria refer to particular criteria for correcting and cropping a particular STI captured at a particular n-FOV_{T}. The cropping includes defining a crop offset and/or a crop center and/or a crop factor. A crop offset is a position of the top left corner of an image in the object domain. A crop factor is given in general by 1/ZF.

In some examples, one may modify the cropping so that a selected object is included in the cropped STI.

In other examples, one may modify the cropping so that a selected object is located at a particular position in the cropped STI.

In some examples and for video mode, one may modify the cropping so that a position of a selected object in two consecutive frames of a video stream does not vary by more than 10% or 5% or 1% of a width and/or height of the Tele sensor.

In other examples, the position of a selected object in two consecutive frames may vary by less than 50 pixel or less than 20 pixel or by even less than 5 pixel (assuming a pixel size of 1 um).

In yet other examples, one may modify the cropping so that a location of a selected object in consecutive frames of a video stream varies only slowly, e.g. vary at a frequency no higher than 10 pixel/s or 5 pixel/s or even 2 pixel/s (assuming a pixel size of 1 um).

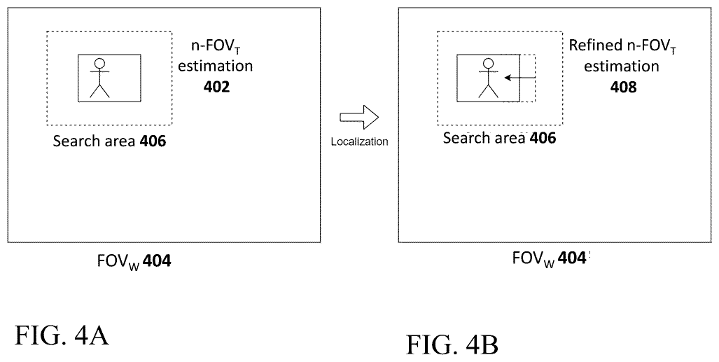

In yet other examples, one may modify the cropping so that a location of a selected object satisfies aesthetic criteria. Aesthetic criteria may be based for example on the location of a selected object in the cropped STI (“aesthetic framing”) as see e.g. photographer's “rule of thirds”, whether additional objects are included or excluded in the cropped STI as see e.g. photographer's “rule of leading lines”, etc. . . . Localization of the STI within the WI is performed in step 306, for example as described in FIG. 4A-B. Image registration between the cropped STI and the WI as known in the art is performed in step 308. Output image data switching may be performed in step 310, as outlined in more detail below. The same steps may be performed for a zoom-out case, where one may switch from Tele output image data to Wide output image data. In some examples, the switching step may include blending or fusing of STIs and WIs.

FIG. 4A-B shows details of the localization of a STI within a WI performed in step 306, as also described in more detail in co-owned international patent application PCT/IB2020/061461.

In FIG. 4A, n-FOV_{T} estimation 402 is shown at an estimated POV within FOV_{W} 404. An estimated POV refers to a POV as estimated from calibration data. The n-FOV_{T} estimation is calibration dependent and may be insufficiently accurate in terms of matching STIs with WIs. Typically, before localization, image point coordinates of a same object point in a STI and WI may deviate by more than 25, 50 or even 100 pixels. We assume a pixel size of about 1 um. The localization (step 306) is performed to decrease this deviation, i.e. to achieve a refined n-FOV_{T} estimation with improved accuracy. The localization includes:
1. Selecting a search area 406 as shown in FIG. 4A. Search area 406 may be defined by using the center of the n-FOV_{T} estimation, and to (e.g. symmetrically) embed it in a rectangular area, wherein the rectangular area may be twice or three times or four times the area covered by the n-FOV_{T} estimation.
2. Cropping the search area from a WI.
3. Template matching, wherein a source is represented by the cropped search area from a WI and a template may be represented by a STI. The template matching may be performed by cross-correlation of the template over different locations of the search area or over the entire search area. The location with a highest matching value may indicate a best estimation of n-FOV_{T}'s location within FOV_{W}. This more accurate refined n-FOV_{T} estimation is indicated in FIG. 4B as 408 and may be further used to perform steps 308 and 310. Typically, after the localization, image points of a same object point may deviate by less than 5 pixels or even by less than 2 pixels between a WI and a STI, i.e. an accuracy is improved by a factor 5, 10 or even 20.

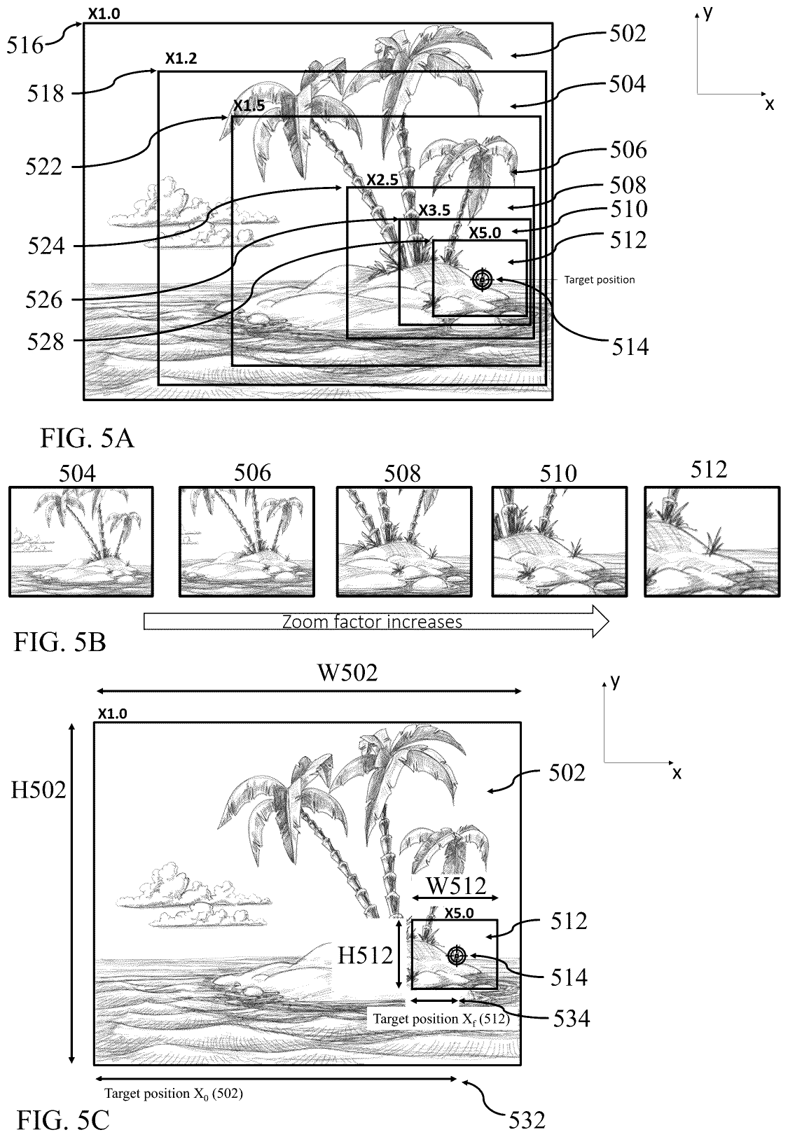

FIG. 5A-C illustrates a ST video sequence created by a first crop method (“method 1”) disclosed herein. In the following, index “0” refers to an initial state, index “f” refers to a final (or target) state and index “t” refers to some intermediate state. “State” refers to an image defined by a ZF, a crop factor and a crop offset. “Final state” refers to a last image displayed in a ST video sequence that includes Wide output image data. Output image data switching may be performed when further zooming-in.

FIG. 5A shows how a zoom-in scenario is displayed in a ST video sequence created by method 1. Image 502 may represent a first image in the ST video sequence. Image 502 may have a ZF=1.0, i.e. it includes an entire FOV_{W} or it may have a ZF>1. Images 504-512 represent subsequent images in the ST video sequence towards a “target” position 514 with coordinates (x_{f}, X_{f}) and a target ZF (“ZF?”). Target position 514 is the position towards which the zoom-in is directed. An STC's n-FOV_{T} is scanned such that target position 514 is located at the n-FOV_{T}'s center. Position 514 and ZF_{f} may be selected by a user or by a program before or at the beginning of the zoom-in action. Images 504-512 are Wide output images. Crop offsets of images 504-512 are indicated by image frames 516-528 respectively. An advantage of method 1 is that cropping is selected such that target position 514 is included in each of the images 502-512, i.e. target position 514 is displayed in the entire ST video sequence.

FIG. 5B shows images 504-512 as subsequently displayed to a user in a zoom-in ST video sequence, i.e. they are zoomed digitally such that they have a same width/height ratio.

FIG. 5C shows image 502, image 512 and target position 514. Numeral 532 represents the initial X-coordinate X₀ of target position 514 in the coordinate system of image 502, and numeral 534 represents the target X-coordinate X_{f} of target position 514 in the coordinate system of image 512. Y-coordinates Y₀ and Y_{f} are defined accordingly. Target position 514 is defined in the object domain. Widths and heights of images 502 and 512 (measured along the x axis and the y axis respectively) are given by W502 and W512 and H502 and H512 respectively. Relative positions (“relPos_{0,x}”) and (“relPos_{f,x}”) can be derived from 532 and 534 by relPos_{0,x}=X₀/W502 and relPos_{f,x}=X_{f}/W512. Relative positions in the Y direction may be defined accordingly. The smooth transition is achieved by gradually modifying the relative coordinates of the target position, for both X and Y axes. At target ZF_{f}, the relative position of target position 514 is relPos_{f,x}=relPos_{f,y}=1/2, i.e. target position 514 coincides with the output image center.

Method 1 may be used similarly for zoom-out.

FIG. 6 shows main steps of method 1. One may start at an initial (or “0”) state with a ZF₀<ZFT and with a video stream that displays Wide output images such as images 502-512. A localization of n-FOV_{T} within FOV_{W} such as described in FIGS. 4A-B is performed.

In general, the relative position at some intermediate state (“t”) may be calculated according to relPost=(Xₜ/Wₜ, Yₜ/Hₜ), where Wₜ and Hₜ are respectively the width and height of an output image displayed at intermediate state t, and where Wₜ=W/ZFₜ and Hₜ=H/ZFₜ define a crop factor, where W and H are respectively the width and height of an uncropped WI.

An initial state relative position relPoso is calculated from target coordinates (X₀, Y₀) in the coordinate system of image 502 as relPos₀ =(X₀/W₀, Y₀/H₀), where W₀=W/ZF₀ and H₀=H/ZF₀ are respectively the width and height of the output image displayed at initial state 0. A transition slope S for transition from relPos₀ to a relative position in the target state relPosr is derived by

$$S = \frac{r elPosf - relPos 0}{ZFP - ZF 0}$$

where ZF_{P} is a pre-set and fixed ZF value which fulfills ZFₚ≥ZFT.

In step 602, a program or user triggers a command for zoom-in to a first intermediate state (“t1”) with a ZF ZFₜ₁, wherein ZFₜ₁≥ZFT, such that output image data switching (from Wide to STC image data) may be performed. The initial output image may be an image that displays the entire FOV_{W} (i.e. having ZF₀=1), or it may be an image having 1<ZF₀<ZFT that displays a (digitally zoomed) segment of FOV_{W}.

In step 604, the relative position update is calculated according to relPosₜ₁=relPos₀+(ZFₜ₁−ZF₀)·S. In general, a relative position update may be relPos=relPostₜ₋₁+(ZFₜ-ZFₜ₋₁) ·S.

In step 606, the crop factor and crop offset are calculated. A crop offset (X_{C}, Y_{C}) is calculated by first calculating the relative coordinates as follows: Xₜ₁=relPos_{t1,x}·Wₜ₁ and Yₜ₁=relPost_{t1,y}·Hₜ₁, where relPos_{t,x} and relPos_{t,y} are the x value and y value of relPosₜ respectively. The crop offset's location (X_{C}, Y_{C}) is calculated by subtracting Xₜ₁ and Yₜ₁ from the target coordinates (in the coordinate system of image t1).

In step 608, an image based on WI data and cropped according to the crop offset (X_{C}, Y_{C}) and having an image size (Wₜ, Hₜ) is output and displayed in the ST video sequence. If further zoom-in is performed, the flow may start again from step 602.

In some examples, a following output image data switching may be from only using a WI input to only using a STI input.

In a second crop method (“method 2”), the ST may be achieved by modifying the crop offset linearly. One may think of a linear connection between the initial crop offset (X_{C,0}, Y_{C,0}) and the target crop offset (X_{C,f}, Y_{C,f}). In method 2, when zooming-in or zooming-out, the crop offset always comes to lie on this linear connection, as shown in FIG. 5A. In some examples, the location where the crop offset comes to lie on the linear connection is determined linearly. In other examples, the location is determined by a square law. For example, a difference in the location of the crop offset (i.e. a distance between the respective crop offsets) on the linear connection is 2 times larger when zooming from ZF=1 to ZF=2 than when zooming from ZF=2 to ZF=4.

In a third crop method (“method 3”), the ST may be achieved by modifying the center of the FOV shown in the ST video stream linearly. One may think of a linear connection between the initial FOV center and the target FOV center. In method 3, when zooming-in or zooming-out, the FOV center may always come to lie on this linear connection. The location where the crop offset comes to lie on the linear connection may be determined by a linear law or by a square law. FIG. 7 shows an embodiment of a ST method disclosed herein. For each image of a video stream, Wide and Tele input images and a STC's POV are retrieved in step 702. The Tele input image may be rectified beforehand to be aligned with the Wide POV, or be rectified in step 702. Optionally, in step 702 an OFPE position may be translated into a n-FOV_{T} estimation using calibration data. For example, in case n-FOV_{T} changed by scanning, a registration process may be executed to calculate the current STI's translation and rotation parameters with respect to WIs. The translation may compensate for the parallax, the rotation for the residual rotation between the STIs and WIs, which may be caused by imperfect calibration.

In some examples, a multi-camera may include image stabilization (IS) such as optical image stabilization (OIS) or electronic image stabilization (EIS) for the STC and/or the WC. Since the IS may shift WIs and STIs with respect to each other, IS control input data such as sensor data provided from an inertial measurement unit (IMU) or IS control output data such as commands to move a particular optical component by a given amount may be read in step 702. The data may be transformed to an expected pixel shift in the WIs and STIs, and the transformation may be used for compensating any undesired effects the IS mechanism may have on a ST video sequence. As known, for EIS, input images are cropped and shifted, so that a selected object or an entire scene remains located at a same (or at a similar) particular position in two or more consecutive output images of a video stream. To prevent jumping between STC and WC, values of ZF_{UP} and/or ZF_{DOWN} in a digital image-stabilized video mode may be 2.5%-50% larger than values of ZFUP and/or ZF_{DOWN} in a non-image-stabilized video mode. Moreover, a capability of performing EIS, e.g. measured by a maximum number of pixels that can be shifted, may be larger by 2.5%-50% at a center POV than at a margin POV. Here, the IS may be used for achieving two different goals. The first goal may be to stabilize a WC or STC at high frequencies of about 50-100 Hz and higher, e.g. for mitigating a user's handshake. The first goal may be to robustly frame a scene, i.e. to stabilize a WC or STC on low frequencies of about 20 Hz and lower, e.g. 1 Hz, to maintain a selected scene (of the object domain) within, or at a particular position within FOV_{W} or n-FOV_{T}. A Wide or a Tele input image is selected to be used as output image in step 704. Wide input image data may be selected for following cases:
for any low ZF, or
for a high ZF, but where one or more non-switching criteria are fulfilled. Evaluating the non-switching criteria prevents output image data switching in situations where a ST cannot be achieved or may not be beneficial. The following non-switching criteria may be evaluated after STIs were captured:
1. Low STI quality. For example, the low image quality may be caused by large electronic noise as of low scene illumination, because the STC is out-of-focus (“defocus blur”), or because of motion blur, rolling shutter artifacts or other artifacts known in the art.
2. Non-suitable STI composition. For example, this may include a scenario (i) where the STI shows a scene significantly different from the scene shown in a WI that is to precede the STI in the ST video stream output to a user, or a scenario (ii) where the STI shows a scene that is in significant semantic disagreement with the scene shown in the WI (e.g. as of motion occurring between the capture of the STI and the WI), or a scenario (iii) where the STI does not show a ROI that is included in the WI (e.g. as of obstructions), or it does show a ROI at a significant mis-location with respect to the WI (i.e. the target coordinates in a WC coordinate system differ significantly from the target coordinates in a STC coordinate system).
3. Imperfect STI correction, e.g. an imperfect roll correction of the STI.

The following non-switching criteria may be evaluated before STIs are captured or before n-FOV_{T} is scanned to particular target coordinates:
1. Valid STC scan range: evaluates whether the target coordinates are included in s-FOV_{T}.
2. Prevent STC-WC jumping: evaluates whether the target coordinates are closer than some threshold to a margin of s-FOV_{T}. In such a case, even a small relative movement of the ROI and the STC may lead to a situation where the ROI cannot fully be covered by the STIs anymore, such that WIs must be used. To prevent this jumping between STC and WC, one may not switch to STI output data if target coordinates are located at a distance closer to 5% or 10% or 20% of the s-FoV_{T} (in a horizontal or a vertical direction) to the margins of s-FOV_{T}.
3. Valid ROI velocity: evaluates the velocity of an ROI (and respective target coordinates) to analyze whether n-FOV_{T} can follow this movement.

The input image selected as output image is cropped in step 706. Depending e.g. on the selected input image, the current ZF, the required image crop for the input image etc. is calculated. The calculation may be performed according to crop method 1, crop method 2, or crop method 3.The resulting cropped image may be displayed (or output) to a user.

Optionally, and depending for example on a) the selected input image, b) the cropping of the input image, and/or c) the image registration parameters, the ST output image may be rendered in step 708.

In other examples, a method disclosed herein may not include the action of cropping, but may only provide the parameters that are calculated as described herein, and the actions of steps 706 and 708 such as cropping, rendering the video, etc. may be performed on a different program or processor, e.g. on a dedicated hardware (HW) supporting HW acceleration.

For compensating resolution differences between STIs and WIs, one may apply a blurring on the output image.

A rotation correction may be applied in step 708 as well. Lens distortion discrepancy between WC and STC is another challenge. For ST, distortion correction may be applied to all input images, or alternatively, a digital distortion may be applied on only the Tele input images or on only the Wide input images such that they are matched to the respective other input images.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that elements.

All patents, patent applications and publications mentioned in this specification are herein incorporated in their entirety by reference into the specification, to the same extent as if each individual patent, patent application or publication was specifically and individually indicated to be incorporated herein by reference. In addition, citation or identification of any reference in this application shall not be construed as an admission that such reference is available as prior art to the present disclosure.

What is claimed is:

1. A zoom camera, comprising:
a Wide camera with a Wide field of view (FOV_{W}) and operative to output Wide images (WIs);
a folded Tele camera (FTC) including an optical path folding element (OPFE), the FTC having a native Tele FOV (n-FOV_{T}) narrower than FOV_{W}, the FTC being operative to output folded Tele images (FTIs) and to perform optical image stabilization (OIS) by actuating the OPFE; and
a camera controller operatively coupled to the Wide camera and to the FTC and configured to stream a video image stream that displays a continuous zoom-in action into, or a continuous zoom-out action out off a non-center area within FOV_{W},
wherein the video images are provided with a smooth transition when switching from displaying WIs to displaying FTIs or vice versa.

2. The zoom camera of claim 1, the Wide camera including a Wide camera lens, wherein the Wide camera is operative to perform OIS by actuating the Wide camera lens.

3. The zoom camera of claim 1, wherein data from an inertial measurement unit (IMU) is used to calculate an expected pixel shift in the WIs and FTIs.

4. The zoom camera of claim 1, wherein the zoom camera in addition is configured to perform electronic image stabilization (EIS).

5. The zoom camera of claim 4, wherein data from an inertial measurement unit (IMU) is used to calculate an expected pixel shift in the WIs and STIs.

6. The zoom camera of claim 1, wherein the smooth transition is achieved by performing a rotation correction of the FTIs.

7. The zoom camera of claim 1, wherein the smooth transition is achieved by executing registration between the WIs and the FTIs.

8. The zoom camera of claim 1, wherein the smooth transition is achieved by executing a localization between the WIs and the FTIs for performing position matching.

9. The zoom camera of claim 1, wherein the smooth transition is achieved by applying blurring on the WIs and/or the FTIs.

10. The zoom camera of claim 1, wherein the smooth transition is achieved by blending the WIs and FTIs.

11. The zoom camera of claim 1, wherein the switching from displaying WIs to displaying STIs is performed at an up-transfer ZF value (ZF_{UP}), wherein the switching from displaying STIs to displaying WIs is performed at a down-transfer ZF value (ZF_{DOWN}), and wherein ZF_{UP}≥ZF_{DOWN}.

12. The zoom camera of claim 11, wherein the zoom camera in addition is configured to perform EIS, wherein values of ZF_{UP} and/or ZF_{DOWN} in an EIS-stabilized video image stream are 2.5%-50% larger than values of ZF_{UP} and/or ZF_{DOWN} in a non-EIS-stabilized video image stream.

13. The zoom camera of claim 1, wherein the FTC is operative to maintain a selected scene within a particular position within n-FOV_{T}, and wherein the actuation for OIS is performed at high frequencies of 50 Hz or higher, and wherein an actuation for maintaining the selected scene within the particular position within n-FOV_{T} is performed at low frequencies of 20 Hz or lower.

14. The zoom camera of claim 1, wherein for providing the smooth transition, the zoom camera performs one or more calculation steps, and wherein in at least one of the one or more calculation steps hardware acceleration is used.

15. The zoom camera of claim 1, wherein the STC has an effective focal length of 8 mm-50 mm.

16. The zoom camera of claim 1, wherein the Wide camera has an effective focal length of 2.5 mm-20 mm.

17. The zoom camera of claim 1. wherein the zoom camera is included in a smartphone.
